(19) United States
(12) Patent Application Publication
(10) Pub. No.: US 2025/0266699 A1
(43) Pub. Date: Aug. 21, 2025

(54) ELECTRONIC SYSTEM INCLUDING A POWER SUPPLY MODULE AND AN ELECTRONIC DEVICE

(71) Applicant: VALEO COMFORT AND DRIVING ASSISTANCE, Créteil (FR)

(72) Inventor: Monji Moumen, Créteil (FR)

(73) Assignee: VALEO COMFORT AND DRIVING ASSISTANCE, Créteil (FR)

(21) Appl. No.: 18/857,456

(22) PCT Filed: Mar. 29, 2023
(86) PCT No.: PCT/EP2023/058180

§ 371 Date: Oct. 17, 2024

(30) Foreign Application Priority Data
Apr. 19, 2022 (FR) FR2203607

(51) Int. Cl. H02J 7/00; G01S 17/894; H02J 7/34; H02M 3/158; H04B 3/54

(52) U.S. Cl. CPC H02J 7/0063; G01S 17/894; H02J 7/345; H02M 3/1582; H04B 3/548; H02J 2207/20; H02J 2207/50

(57) ABSTRACT

An electronic system includes a power supply module (5) configured to supply power to an electronic device. The electronic device includes at least one light source, a storage battery and a switching module configured so that, in a first configuration, the storage battery is electrically coupled to the power supply module via the switching module and the light source is not supplied with power. In a second configuration, the storage battery is disconnected from the power supply module and electrically coupled to the light source via the switching module so as to supply it with power. The switching module may be a bidirectional chopper, the first configuration of which is a series chopper configuration and the second configuration of which is a parallel chopper configuration.

### TECHNICAL FIELD

The present invention relates to the technical field of electronics, and in particular to management of the electrical consumption of electronic equipment, in particular of imaging devices.

The invention relates most particularly to an electronic system including a power supply module configured to supply power to an electronic device.

### TECHNOLOGICAL BACKGROUND

In the above field, it is known that the power consumption of electronic devices can vary. In particular, one-off activation of some components of the device can generate a substantial consumption peak.

For example, some imaging devices are configured to capture three-dimensional images using a laser diode that emits light, for example infrared light, in a pulsed manner. Activation of this light source generates regular current peaks, which can pose problems.

For example, in the case of an architecture in which the control data of the device and the supply current pass via one and the same coaxial cable, the current peaks flowing through the cable generate electromagnetic noise that can disrupt the transmission of the commands, and therefore the correct operation of the system.

Furthermore, some electronic control units are not capable of delivering sufficiently large current values, and so it may be necessary to use a more efficient and therefore more expensive electronic control unit simply to operate said components, for example simply to operate the laser diode in the case of an imaging device. Thus, for all other operations of the device, the electronic unit is oversized from the point of view of its power supply.

### SUMMARY OF THE INVENTION

The invention provides a solution to the abovementioned problem by way of a system including an electronic control unit supplying power to an electronic device.

According to one aspect of the invention, what is proposed is an electronic system including a power supply module configured to supply power to an electronic device, the electronic device including at least one light source, a storage battery and a switching module configured so that
in a first configuration, the storage battery is electrically coupled to the power supply module via the switching module and the diode is not supplied with power,
in a second configuration, the storage battery is disconnected from the power supply module and electrically coupled to the light source via the switching module so as to supply it with power,
the switching module being a bidirectional chopper, the first configuration of which is a series chopper configuration and the second configuration of which is a parallel chopper configuration.

Thus, courtesy of the invention, the light source, activation of which requires a high current, is supplied with power not directly by the power supply module but rather by the storage battery, which is charged when the light source is inactive, or turned off. Thus, it is possible to supply power to the device using a power supply module with a more limited capacity. Furthermore, avoiding generating too high a current in the system avoids electromagnetic interference problems.

According to one embodiment, the system includes an electronic control unit that includes the power supply module and that is connected to the electronic device by a coaxial cable, the electronic control unit being configured to control and supply power to the electronic device via the coaxial cable.

According to one embodiment, the electronic device is an optical measuring device or an imaging device.

According to one embodiment, the light source is a laser diode.

According to one embodiment, the light source is a vertical cavity surface-emitting laser diode.

According to one embodiment, the switching module is configured to change from the first configuration to the second configuration when the voltage across the terminals of the storage battery reaches a first predetermined value.

According to one embodiment, the switching module is configured to change from the second configuration to the first configuration when the voltage across the terminals of the storage battery reaches a second predetermined value.

According to one embodiment, the system includes an optical sensor.

According to one embodiment, the light source is configured to generate periodic light pulses.

According to one embodiment, the switching module includes a first switch coupled between the electronic control unit and a first terminal of the light source, and/or a second switch coupled between a second terminal of the light source and earth, and/or a capacitor coupled between the first terminal of the light source and earth, and/or a resistor coupled between the first terminal of the light source and a coil, a first terminal of which is coupled to the resistor and a second terminal of which is coupled to a third switch, and/or a fourth switch, a first terminal of which is coupled to the second terminal of the coil and earth, the storage battery being coupled between a second terminal of the fourth switch and earth, the system being configured to be in the first configuration when the first switch is closed and the second switch is open, and in the second configuration when the first switch is open and the second switch is closed.

Of course, the various features, variants and embodiments of the invention may be associated with one another in various combinations provided that they are not mutually exclusive or incompatible.

### BRIEF DESCRIPTION OF THE FIGURES

In addition, various other features of the invention will become apparent from the accompanying description that is provided with reference to the drawings, which illustrate non-limiting embodiments of the invention, and in which:

FIG. 1 is a schematic view of an electronic system according to one embodiment of the invention,

FIG. 2 is a circuit diagram of an electronic device of the system of FIG. 1,

FIG. 3 is a timing diagram illustrating the operation of the electronic device of FIG. 2.

It will be noted that structural and/or functional elements common to the various variants may have the same reference signs in these figures.

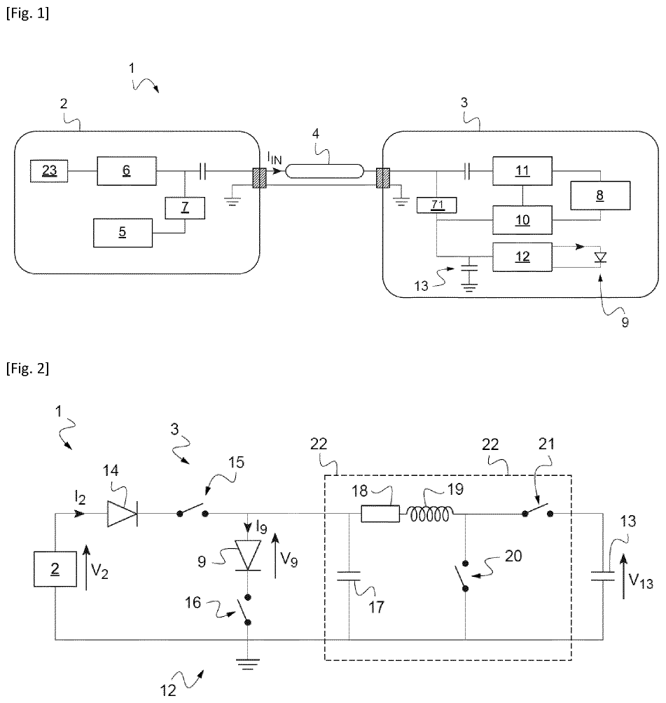

An electronic system as shown schematically in FIG. 1 is denoted as a whole by the reference sign 1.

For example, the system 1 in this case is an optical sensor, for example an imaging system configured to capture images, in particular three-dimensional images or simple depth measurements, in particular by implementing what are called “time-of-flight” measurements. To this end, the system 1 includes a light source 9 that is configured to generate light pulses and an optical sensor 8 that is configured to detect said light pulses, for example after reflection from elements of the environment of the system.

For example, the electronic system 1 may be aboard a motor vehicle and form part of a driver assistance system.

The electronic system 1 in this case includes an electronic control unit 2 (also called ECU) and an electronic device 3. The electronic control unit is configured to supply power to and control the electronic device 3, which includes the sensor 8 and the light source 9. One and the same coaxial cable 4 allows a supply current I2 and computer control instructions to pass from the electronic control unit 2 to the electronic device 3.

The electronic control unit 2 in this case includes a power supply module 5 configured to supply the supply current I2 and a computer processing module configured to generate the computer control instructions.

A serialization circuit 6 is coupled between the computer processing module 23 and the coaxial cable 4 in this case and is configured to adapt the computer instructions for transfer on the coaxial cable 4.

In order to limit interference between the supply current I2 and the computer instructions, the electronic control unit 2 furthermore includes a filter 7 coupled between the power supply module 5 and the coaxial cable 4. In this case, for example, the filter is a PoC (Power over Coax) filter and is used to combine the DC supply signal and the transmitted data.

The electronic device 3 in this case includes a power management integrated circuit (PMIC) 10 coupled between the coaxial cable 4 and the sensor 8, which circuit is configured to perform operations on the supply voltage of the sensor 8, for example operations of regulating and sequencing the power supply.

A deserialization circuit 11 is coupled between the coaxial cable 4 and the sensor 8 and is configured to reshape the computer instructions modified by the serialization circuit 6.

The optical sensor 8 in this case is a photodiode or a set of photodiodes and the light source 9 in this case is a laser diode, for example a vertical cavity surface-emitting laser (VCSEL) diode.

A second filter 71 is used to separate the DC supply signal and the received data.

The electronic device 3 includes a switching module 12 coupled to the light source 9 and to a storage battery 13, in this case a first capacitor. The switching module is either in a first configuration or in a second configuration. Depending on the configuration of the switching module 12, the diode 9 will or will not be supplied with power.

In the first configuration, the switching module 12 is configured to couple the storage battery 13 to the electronic control unit 2 in such a way that it is charged. In this first configuration, the light source 9 is disconnected from the electronic control unit 2 and from the capacitor 13 and is not supplied with power. It therefore does not emit a light signal.

In its second configuration, the storage battery 13 is disconnected from the electronic control unit 2 and is electrically coupled to the light source 9. In this second configuration, the diode 9 is supplied with power by the storage battery 13 and therefore emits a light signal.

Preferably, the length of time for which the switching module 12 is in its first configuration is markedly greater than the length of time for which the switching module is in its second configuration 12, for example at least three times greater, such that the signal emitted by the diode is pulsed.

Thus, supplying power to the light source 9 by way of the storage battery 13 avoids generating a peak in the supply current I2 (corresponding to the light pulse from the light source) in the coaxial cable, since the diode is never supplied with power directly by the electronic control unit but rather by the storage battery 13.

According to some embodiments, the switching module 12 can perform operations on the voltage across the terminals of the diode and on the voltage across the terminals of the first capacitor 13, in particular voltage step-up or voltage step-down operations, as will be seen below.

FIG. 2 is a circuit diagram partially illustrating the electronic device 2, and more particularly in this case illustrating the switching module according to such an embodiment. For the sake of simplicity, the electronic control unit 2 is schematically represented by a single block. The voltage and current delivered by the control module 2 to the switching module 13 in this case are denoted by V2 and I2, respectively.

A non-return diode 14, or reverse current protection diode, is coupled between the electronic control unit 2 and the switching module 12 in this case to avoid a reverse current being able to damage the electronic control unit 2 while the switching module is operating.

The switching module 12 includes a first switch 15, coupled between the cathode of the non-return diode 14 and the anode of the diode 9. A second switch 16 is coupled between the cathode of the diode 9 and earth.

The switching module 12 furthermore includes a second capacitor 17, a first terminal of which is coupled to the cathode of the diode 9 and a second terminal of which is coupled to earth in this case. A resistor 18 is coupled in series with a coil 19 between the first terminal of the second capacitor 17 and a first terminal of a third switch 20, the second terminal of which is coupled to earth.

A fourth switch 21 is coupled between the first terminal of the third switch and a first terminal of the first capacitor 13. A second terminal of the first capacitor 13 is coupled to earth.

In this example, each of the switches 14, 15, 20 and 21 includes a transistor or a set of transistors, for example one or more metal oxide field-effect transistors, or MOSFETs. The switches in this case are controlled by the computer processing module 23.

In the configuration described here, the switching module 12 is a synchronous bidirectional chopper that, in the first configuration, has a series chopper (buck driver) configuration and, in the second configuration, has a parallel chopper (boost driver) configuration.

A dotted frame exhibiting the digital reference 22 delimits that part of the switching module that, in each of the configurations, forms a synchronous chopper (series or parallel). The opening and closing, in a complementary manner, of the two switches 15 and 16 is used to change from the first configuration to the second configuration. Thus, the chopper 22 and the switches 14 and 15 (controlled by the computer processing module) form the bidirectional chopper.

In particular, in the first configuration, the first switch 15 is closed (the one or more corresponding MOSFETs are on) and the second switch 16 is open (the one or more MOSFETs are off). The chopper 22 behaves as a series chopper, the input voltage of which is the voltage V2, and the output voltage of which is the voltage V13 across the terminals of the first capacitor 13.

In the second configuration, the first switch 15 is open (the one or more corresponding MOSFETs are off) and the second switch 16 is closed (the one or more MOSFETs are on). The chopper 22 behaves as a parallel chopper, the input voltage of which is the voltage V13 across the terminals of the first capacitor, and the output voltage of which is the voltage V9 across the terminals of the diode 9.

In one or the other of the first configuration and the second configuration, the third switch 20 and the fourth switch 21 are configured to switch in a complementary manner.

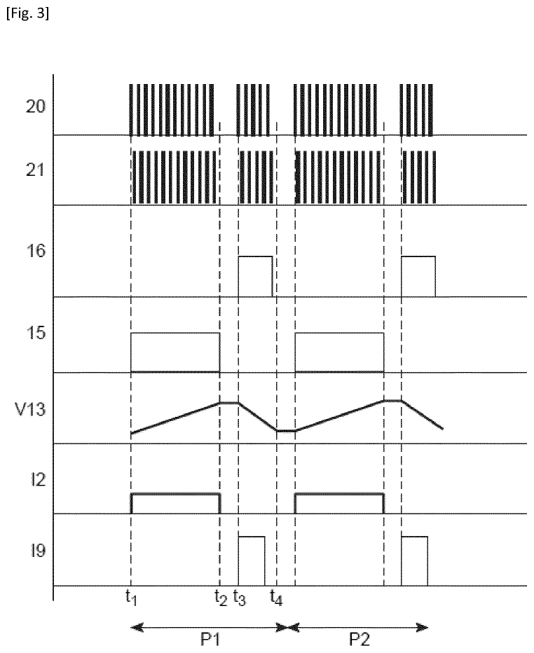

The operation of the switching module 12 will be described below in conjunction with the timing diagram of FIG. 3.

The first four lines of the timing diagram relate to the states of the switches 15, 16, 20 and 21 (or to the gate voltages of the corresponding transistors). In these lines, a high level corresponds to a closed, or on, state of the corresponding switch and a low, or zero, level corresponds to an open, or off, state of the corresponding switch.

The fifth line of the timing diagram illustrates the variation in the voltage V13 across the terminals of the first capacitor 13. The sixth line of the timing diagram illustrates the variation in the supply current I2 and the seventh and last line illustrates the variation in the current I9 flowing through the diode 9.

Two successive periods P1 and P2 of the switching module in operation are illustrated in this case. In each period, the switching module is firstly in the first configuration and then in the second configuration. Initially, all of the switches are open, or off.

At a first time t1, the switching module changes to the first configuration. The first switch 15 turns on and the second switch remains off. The third switch and the fourth switch switch in a complementary manner. For example, the duty cycle al of the third switch 20 in the first configuration is in this case determined according to the following formula:

$$α1 = ( V 13 - V 2 ) / V 13 \qquad [ Math . 1 ]$$

The first capacitor 13 charges and the voltage V13 across its terminals gradually increases. The current I2 takes a first value. Owing to the series chopper configuration of the switching module 13, the voltage V13 across the terminals of the capacitor is higher than the voltage between the anode of the diode 9 and earth.

When the voltage V13 reaches a predetermined voltage threshold, in this case at a second time t2, all of the switches change to the off state until a third time t3. Between the times t2 and t3, the switching module is in a transient configuration, that is to say that it is neither in the first configuration nor in the second configuration. During this period, the voltage V13 across the terminals of the first capacitor 13 remains substantially constant and no current flows in the switching module 12. A transient period such as this is advantageous in order to avoid the first switch 15 and the second switch 16 being on simultaneously.

At the third time t3, the switching module 12 changes to the second configuration. The second switch 16 turns on and the first switch 15 remains off. The third switch 20 and the fourth switch 21 switch in a complementary manner. For example, the duty cycle of the third switch 20 in the second configuration is in this case determined according to the following formula:

$$α1 = V 9 / V 13 , \qquad [ Math . 2 ]$$

The first capacitor 13 discharges and supplies power to the diode 9 through which the current I9 flows. Owing to the parallel chopper configuration of the switching module 12, the voltage V13 across the terminals of the capacitor is higher than the voltage across the terminals of the diode 9.

When the voltage V13 across the terminals of the first capacitor 13 reaches a second predetermined threshold, in this case at a fourth time t4, the switching module 12 changes back to the transient configuration and all of the switches change to or remain in an off state.

The second period P2 progresses analogously to the course of the first period.

The embodiments described here with reference to FIGS. 1 to 3 are not in any way limiting. In particular, although a connection between the electronic control unit 2 and the electronic device 3 via a coaxial cable has been described here, the invention is compatible with communication and power via separate lines.

Moreover, the modes of implementation of the switches in the form of one or more MOSFETs described here are in no way limiting, and it would be conceivable to implement the switches in any other way.

Various other modifications can be made to the invention within the scope of the appended claims.

1. An electronic system comprises:
a power supply module;
an electronic device,
wherein said power supply module is configured to supply power to an electronic device,
wherein the electronic device comprises:
at least one light source,
a storage battery, and
a switching module,
the electronic system being configured so that:
a first configuration, the storage battery is electrically coupled to the power supply module via the switching module and the light source is not supplied with power; and
a second configuration, the storage battery is disconnected from the power supply module and electrically coupled to the light source via the switching module so as to supply it with power,
wherein the switching module is a bidirectional chopper, the first configuration of which is a series chopper configuration and the second configuration of which is a parallel chopper configuration.

2. The electronic system according to claim 1, further comprising:
an electronic control unit that includes the power supply module and that is connected to the electronic device by a coaxial cable,
wherein the electronic control unit is configured to control and supply power to the electronic device via the coaxial cable (4).

3. The electronic system according to claim 1, the system is an optical measuring device or an imaging device.

4. The electronic system according to claim 1, wherein the light source is a laser diode.

5. The electronic system according to claim 4, wherein the light source is a vertical cavity surface-emitting laser diode.

6. The electronic system according to claim 1, wherein the switching module is configured to change from the first configuration to the second configuration when the voltage across the terminals of the storage battery reaches a first predetermined value.

7. The electronic system according to claim 1, wherein the switching module is configured to change from the second configuration to the first configuration when the voltage across the terminals of the storage battery reaches a second predetermined value.

8. The electronic system according to claim 4, including an optical sensor.

9. The electronic system according to claim 1, wherein the light source is configured to generate periodic light pulses.

10. The electronic system according to claim 1,
wherein the switching module comprises:
a first switch coupled between the power supply module and a first terminal of the light source;
a second switch coupled between a second terminal of the light source and earth;
a capacitor coupled between the first terminal of the light source and earth;
a resistor coupled between the first terminal of the light source and a coil;
a first terminal coupled to the resistor and a second terminal of coupled to a third switch;
a fourth switch; and
a first terminal coupled to the second terminal of the coil and earth,
wherein the storage battery is coupled between a second terminal of the fourth switch and earth; and
wherein the electronic system is configured to be in the first configuration when the first switch is closed and the second switch is open, and in the second configuration when the first switch is open and the second switch is closed.
